(19) United States
(12) Patent Application Publication
(10) Pub. No.: US 2007/0289288 A1
(43) Pub. Date: Dec. 20, 2007

(54) VENTING OF ON-BOARD VEHICLE EMISSIONS TREATMENT SYSTEM WITH PRESSURE ASSIST

(75) Inventors: Kent Dawson, Romeo, MI (US); Furqan Shaikh, Troy, MI (US); Michael Levin, Ann Arbor, MI (US); David Cook, Albuquerque, NM (US); Daniel Kabat, Oxford, MI (US)

Correspondence Address: BIR LAW, PLC/FGTL, 13092 GLASGOW CT., PLYMOUTH, MI, 48170-5241, US

(73) Assignee: FORD GLOBAL TECHNOLOGIES, LLC, DEARBORN, MI (US)

(21) Appl. No.: 11/424,917

(22) Filed: Jun. 19, 2006

(51) Int. Cl. F02M 25/06; F01N 5/00; F01N 3/00

(52) U.S. Cl. 60/279; 60/281; 60/286; 60/295

(57) ABSTRACT

A system and method for venting an on-board vehicle emissions treatment substance storage and distribution system that selectively dispenses an emissions treatment substance from a storage tank on the vehicle to an exhaust system of the vehicle include pressurizing the storage tank during engine operation and coupling the storage tank to the exhaust system upstream of an ammonia storage element to reduce and direct any escaping ammonia toward the rear of the vehicle away from a refueling location.

### BACKGROUND

1. Technical Field.

The present disclosure relates to systems and methods for venting an on-board emissions treatment system of a vehicle.

2. Background Art.

Various types of vehicle emission control systems introduce one or more substances directly or indirectly to the engine via the fuel supply, air/fuel intake, exhaust, or directly to an engine cylinder or emissions control device, such as a catalyst. For example, substances acting as reducing agents or reductants, such as aqueous urea or hydrocarbons (other than fuel) may be used in lean air/fuel ratio engine applications including diesel engines in combination with lean NOx catalysts (or selective catalytic reduction (SCR)) to treat nitrous oxide feedgas emissions. These substances generally require a storage and distribution system separate from the primary fuel storage and distribution system.

Liquid urea selective catalytic reduction (SCR) is a method of mobile exhaust aftertreatment particularly suited for diesel engines for treating oxides of nitrogen (NOx) emissions. In a representative liquid urea SCR application, a urea solution, typically 33% urea in water, is stored on board the vehicle and metered or dosed by a pump and injector into the exhaust where it decomposes by thermal hydrolysis to ammonia and carbon dioxide. Ammonia then reacts over the SCR catalyst to reduce NOx compounds to nitrogen, oxygen, and water before being released to atmosphere.

Urea stored on-board the vehicle poses unique technical challenges. For example, when subjected to temperatures common for underbody exhaust components, urea stored in the tank may begin to decompose and release ammonia to the air space above the liquid. In an open vented tank system, some ammonia, which is lighter than air, may travel up and out the tank vent. Because ammonia has a pungent odor that most humans can detect in concentrations as low as 5-20 ppmv, it is desirable to eliminate, minimize, and/or delay ammonia escape from the emissions treatment system and/or to direct any escaping ammonia away from locations such as the refueling door where vehicle operators/passengers are more likely to be present after shutting off the engine. Prior art approaches have employed a selectively operable fan to introduce air into the reductant storage tank or to remove vapors from the tank as disclosed in US2003/0213234 and WO2005/028826, for example.

### SUMMARY

A system and method for venting an on-board vehicle emissions treatment substance storage and distribution system that selectively dispenses an emissions treatment substance from a storage tank on the vehicle to an exhaust system of the vehicle include pressurizing the storage tank during engine operation and directly coupling the storage tank to the exhaust system upstream of an ammonia storage element to abate ammonia from the system or direct any escaping ammonia away from locations where people are more likely to be present.

Embodiments include an on-board emissions treatment system having a constant, passive coupling between a vehicle emissions treatment substance storage tank and a vehicle exhaust system so that exhaust pressure generated by operation of the engine increases pressure within the storage tank, which may assist the emissions treatment substance pump and distribution system and reduce vaporization of the emissions treatment substance in the space above the liquid within the tank. Exhaust pressure also inhibits or delays migration of vapors from the storage tank

The embodiments provide various advantages. For example, passive venting of the emissions substance treatment systems using urea through the exhaust system upstream of an ammonia storage device reduces or eliminates escaping ammonia. Any ammonia that escapes is diluted by exhaust gases during operation and redirected through the exhaust system, which is generally away from the refueling area and less likely to be objectionable to the operator or passengers. Passive venting does not require modifications to the vehicle control system and adds minimal cost/complexity to the vehicle. Coupling the emissions treatment substance storage tank to the exhaust passively pressurizes the storage tank to reduce vaporization while not using additional energy/power to operate a fan or other device to control venting. Increasing pressure in the coupling between the storage tank and the exhaust system delays or impedes migration of vapors from the storage tank. Similarly, venting the storage tank upstream of a catalyst allows vapors to be stored for some period of time depending on the vaporization rate, which also impedes or delays the escape of vapors from the system. Providing a continuous coupling between the storage tank and exhaust system allows venting of the storage tank even during long shut down periods. As such, the embodiments reduce or eliminate detectable odor associated with the release of untreated vapors from a vehicle emissions treatment system.

The above advantages and other advantages and features will be readily apparent from the following detailed description of the preferred embodiments when taken in connection with the accompanying drawings.

### BRIEF DESCRIPTION OF THE FIG.

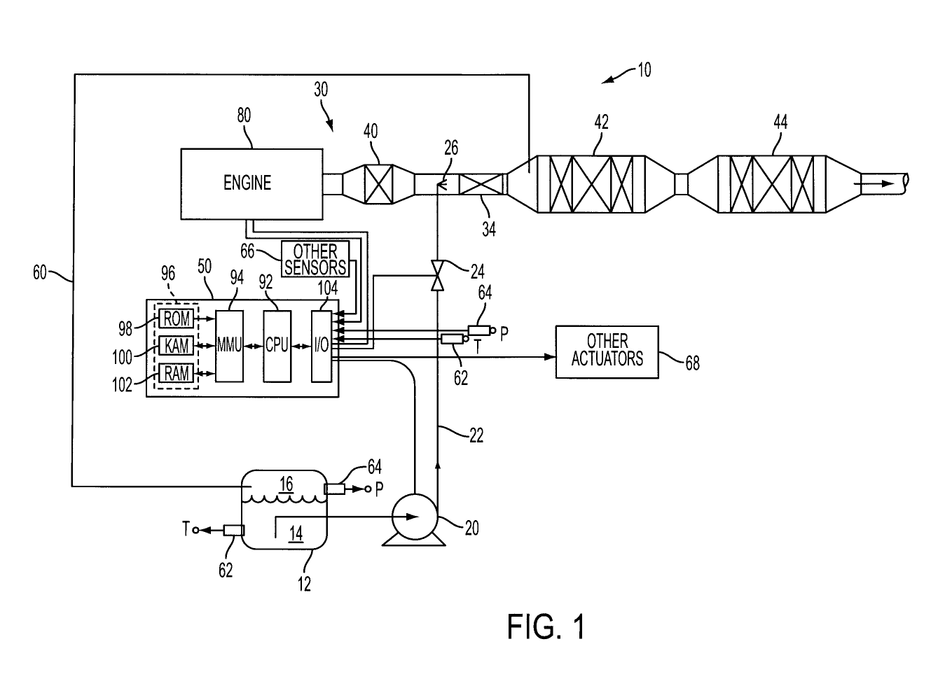

FIG. 1 is a block diagram illustrating one embodiment of a system or method for venting an on-board vehicle emissions treatment system with passive pressure assist.

### DETAILED DESCRIPTION OF THE PREFERRED EMBODIMENT(S)

As those of ordinary skill in the art will understand, various features of the embodiments illustrated and described with reference to the Figure may be combined with other features to produce embodiments that are not explicitly illustrated or described. The combination of features illustrated provides a representative embodiment for typical applications. However, various combinations and modifications of the features consistent with the teachings of this disclosure may be desired for particular applications or implementations.

Referring now to FIG. 1, a block diagram illustrating one embodiment of a system or method for venting an on-board vehicle emissions treatment system with pressure assist is shown. System 10 includes an emissions treatment substance storage tank 12 mounted on a vehicle (not shown). Storage tank 12 may be used to store an emissions treatment substance 14, which may include, but is not limited to various reducing agents or reductants such as aqueous urea, hydrocarbons (other than the primary fuel), etc. Storage tank 12 may be a single or multiple wall storage tank having a generally rigid exterior and may optionally include an interior bladder that contains emissions treatment substance 14. However, the features and advantages of the present disclosure are independent of the particular type of storage tank 12. Storage tank 12 includes a vapor/air space 16 that varies in volume relative to the quantity of emissions treatment substance 14 in tank 12. A fill pipe (not shown) extends from storage tank 12 and terminates at a filler neck adapted for receiving a filling nozzle to add emissions treatments substance 14 to storage tank 12.

Pump 20 is fluidly coupled to storage tank 12 and in communication with controller 50, which controls operation of pump 20. During operation, pump 20 pumps emissions treatment substance 14 from tank 12 to pressurize a supply line 22. A dosing or metering valve 24 is selectively controlled by controller 50 in response to current operating conditions or parameters of exhaust system 30 and/or engine 80 to deliver emissions treatment substance 14 via a corresponding nozzle or injector 26 to exhaust system 30 upstream of a mixing element or mixer 34, which mixes the exhaust stream from engine 80 with injected emissions treatment substance 14. Exhaust system 30 includes various emissions control/treatment devices that may include a pre-oxidation catalyst 40, a selective catalytic reduction (SCR) catalyst 42, and a diesel particulate filter (DPF) 44, for example. Of course, the presence and/or sequence of particular emissions treatment/control devices may vary depending upon the particular type of fuel, engine control strategy, and other factors affecting a particular application or implementation.

As also illustrated in FIG. 1, system 10 includes a device implemented by a fluid coupling 60 that connects or couples storage tank 12 and exhaust system 30. Fluid coupling 60 is a passive or constant coupling that constantly and continuously couples space 16, preferably above a maximum level of emissions treatment substance 14, of storage tank 12 to exhaust system 30 to allow bidirectional flow. Fluid coupling 60 allows flow of exhaust from exhaust system 30 to pressurize or increase pressure within tank 12 during operation of engine 80. Increasing pressure in tank 12 may reduce vaporization of the liquid emissions treatment substance in addition to providing some assistance for pump 20 in pressurizing supply line 22.

In the representative embodiment illustrated, space 16 of storage tank 12 is continuously coupled or vented to exhaust system 30 via fluid coupling 60. A coupling with bidirectional flow between space 16 and exhaust system 30 directs any vapors from storage tank 12 generally away from the vehicle and occupants, particularly during filling of emissions treatment substance storage tank 12 or refueling of the vehicle. While venting of tank 12 away from an associated filling tube (not shown) reduces or eliminates detection of odor during filling of tank 12 and during vehicle refueling by vehicle operators/occupants, additional benefits of judicious routing of fluid coupling 60 may be provided by coupling tank 12 to a device (or upstream of a device) that can decompose or store the vapor for future treatment to reduce or eliminate vapor escape from system 10. In the representative embodiment illustrated in FIG. 1, tank 12 is continuously fluidly coupled to exhaust system 30 upstream of a vapor storage/decomposition device implemented by SCR catalyst 42. Depending upon the current operating temperature of SCR catalyst 42, vapor from tank 12 will react with exhaust flow from engine 80, or may be stored by SCR catalyst 42 and subsequently reacted when a suitable operating temperature is reached. For example, while engine 80 is operating or has just been shut off, exhaust pressure increases pressure in tank 16 to reduce vaporization and slow transit time of any vapor through fluid coupling 60 to exhaust system 60. When vapor pressure within tank 12 exceeds exhaust pressure of exhaust system 30, any vapors may begin to travel through device 60 toward exhaust system 30. Vapors reaching exhaust system 30 when SCR catalyst 42 is above an appropriate operating temperature will be reacted with exhaust constituents in SCR catalyst 42. When SCR catalyst 42 is below operating temperature, vapor traveling to exhaust system 30 through fluid coupling 60 is stored by SCR catalyst 42 for subsequent reaction when SCR catalyst 42 reaches operating temperature.

As those of ordinary skill in the art will appreciate, system 10 may include an emissions treatment system temperature sensor 62 and/or pressure senor 64 in addition to one or more conventional sensors 66 and actuators 68 to control system 10. Various sensors and actuators may communicate with at least one dedicated or general-purpose controller 50 that includes a microprocessor 92, also called a central processing unit (CPU), in communication with a memory management unit (MMU) 94 to control engine 80, exhaust system 30, and the emissions treatment system. MMU 94 controls movement of data and/or instructions among various computer readable storage media 96 and communicates data to and from CPU 92. The computer readable storage media preferably include volatile and nonvolatile or persistent storage in read-only memory (ROM) 98, keep-alive memory (KAM) 100, and random-access memory 102, for example. KAM 100 may be used to store various engine and/or ambient operating variables while CPU 92 is powered down. Computer-readable storage media 96 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by CPU 92 in controlling system 10. Computer-readable storage media 96 may also include floppy disks, CD-ROMs, hard disks, and the like depending upon the particular application. CPU 92 communicates with the sensors and actuators via an input/output (I/O) interface 104. Interface 104 may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to CPU 92. Some controller architectures do not contain an MMU 94. If no MMU 94 is employed, CPU 92 manages data and connects directly to ROM 98, KAM 100, and RAM 102. Of course, more than one controller 90 or more than one CPU 92 may be used to provide system control and each controller 90 may contain multiple ROM 98, KAM 100, and RAM 102 coupled to MMU 94 or CPU 92 depending upon the particular application.

As previously described, controller 50 may control engine 80 in addition to various components of the emissions treatment system, such as pump 20 and injector 26. Controller 50 controls operation of pump 20 to pressurize supply line 22 with emissions treatment substance 14. Various components in exhaust system 30, such as catalysts 40, 42 and DPF 44 obstruct exhaust flow and create exhaust pressure or back pressure during operation of engine 80. The exhaust pressure pressurizes coupling 60 and emissions storage tank 12 to reduce vapor formation within tank 12 and impede vapor transmission or escape from tank 12. When pressure within tank 12 exceeds the pressure in exhaust system 30, vapors may enter exhaust system 30 from tank 12 where they are stored or reacted by SCR catalyst 42.

As such, passive venting of the emissions substance treatment system using urea through the exhaust system upstream of an ammonia storage device according to the present disclosure reduces or eliminates escaping ammonia. Any ammonia that escapes is redirected through the exhaust system, which is generally away from the refueling area and less likely to be objectionable to the operator or passengers. Passive venting does not require modifications to the vehicle control system and adds minimal cost/complexity to the vehicle. Continuous coupling of the emissions treatment substance storage tank to the exhaust passively pressurizes the storage tank during operation of the engine to reduce vaporization in the storage tank and to reduce or delay vapor migration from the storage tank and/or any subsequent escape of vapors while not using additional energy/power to operate a fan or other device to control venting. As such, the embodiments reduce or eliminate detectable odor associated with the release of untreated vapors from a vehicle emissions treatment system

While the best mode has been described in detail, those familiar with the related art will recognize various alternative designs and embodiments within the scope of the following claims.

What is claimed:

1. A method for venting an on-board vehicle emissions treatment system that selectively dispenses an emissions treatment substance from a storage tank to an exhaust system located downstream of an internal combustion engine of the vehicle, the method comprising:
pressurizing the storage tank during operation of the internal combustion engine to reduce vapor formation in the tank and assist the emissions treatment substance distribution pump.

2. The method of claim 1 wherein the step of pressurizing comprises pressurizing the storage tank using exhaust from the internal combustion engine.

3. The method of claim 1 wherein the step of pressurizing comprises continuously fluidly coupling the storage tank to the exhaust system.

4. The method of claim 3 wherein the exhaust system includes a catalyst and wherein the step of continuously fluidly coupling the storage tank comprises coupling a portion of the storage tank above a maximum level of the emissions treatment substance to the exhaust system upstream of the catalyst to deliver any vapors from the storage tank to the exhaust system when storage tank pressure exceeds exhaust system pressure.

5. The method of claim 1 wherein the emissions treatment substance includes aqueous urea, the exhaust system includes an element for storing ammonia when operating below a predetermined temperature and reacting ammonia otherwise, and wherein the step of coupling the storage tank comprises coupling the storage tank to the exhaust system upstream of the element.

6. The method of claim 5 wherein the step of coupling the storage tank to the exhaust system comprises coupling the storage tank to the exhaust system downstream of an emissions treatment substance injector.

7. The method of claim 1 wherein the emissions treatment substance comprises aqueous urea.

8. An on-board vehicle emissions treatment system that selectively dispenses an emissions treatment substance from a storage tank on the vehicle to an exhaust system associated with an internal combustion engine of the vehicle, the emissions treatment system comprising:
a device for pressurizing the storage tank using exhaust from the vehicle during operation or nonoperation of the internal combustion engine.

9. The system of claim 8 wherein the device comprises a fluid coupling connecting the storage tank to the exhaust system.

10. The system of claim 9 wherein the fluid coupling couples a space above a maximum emissions treatment substance level of the storage tank to the exhaust system.

11. The system of claim 8 further comprising a catalyst positioned downstream of the internal combustion engine, wherein the device for pressurizing the storage tank couples the storage tank to the exhaust system upstream of the catalyst.

12. The system of claim 8 further comprising:
a catalyst positioned downstream of the internal combustion engine;
an emissions treatment substance fluid pump coupled to the storage tank; and
an emissions treatment substance injector coupled to the fluid pump and at least partially disposed within the exhaust system, wherein the device for pressurizing the storage tank couples the storage tank to the exhaust system downstream of the injector and upstream of the catalyst.

13. The system of claim 12 further comprising a controller in communication with the fluid pump and injector for controlling injection of the emissions treatment substance into the exhaust system.

14. The system of claim 8 wherein the emissions treatment substance comprises aqueous urea.

15. The system of claim 8 wherein the storage tank comprises a rigid tank.

16. The system of claim 15 wherein the storage tank further comprises an expandable bladder contained within the rigid tank for holding the emissions treatment substance.

17. An on-board vehicle emissions treatment system for an internal combustion engine, the emissions treatment system comprising:
a storage tank located on the vehicle for storing an emissions treatment substance;
a pump fluidly coupled to the storage tank for selectively pressurizing a supply line with the emissions treatment substance;
an injector in fluid communication with the supply line and the pump and having at least a portion disposed within an exhaust stream of the internal combustion engine for selectively injecting the emissions treatment substance into the exhaust stream; and
a fluid coupling connected to the storage tank and the exhaust stream of the internal combustion engine to continuously fluidly couple a space above liquid in the storage tank to the exhaust stream and allow bidirectional flow therebetween to pressurize the storage tank with exhaust from the internal combustion engine during operation of the internal combustion engine and vent the storage tank to the exhaust stream when pressure in the storage tank exceeds pressure of the exhaust stream.

18. The system of claim 17 further comprising:
a catalyst disposed within the exhaust stream downstream of the internal combustion engine, wherein the fluid coupling couples the storage tank to the exhaust stream between the internal combustion engine and the catalyst.

19. The system of claim 18 wherein the fluid coupling couples the storage tank to the exhaust stream between the emissions treatment substance injector and the catalyst.

20. The system of claim 18 wherein the emissions treatment substance comprises aqueous urea.
